(19) United States
(12) Patent Application Publication
(10) Pub. No.: US 2009/0197074 A1
(43) Pub. Date: Aug. 6, 2009

(54) METAL COMPOSITE MATERIAL AND PROCESS FOR PRODUCTION OF METAL COMPOSITE MATERIAL

(75) Inventors: Makoto Fujita, Anjo-shi, (JP); Kunio Kumagai, Anjo-shi (JP); Masaoki Hashimoto, Aichi-gun (JP); Kazuko Hashimoto, Aichi-gun (JP)

Correspondence Address: DARBY & DARBY P.C., P.O. BOX 770, Church Street Station, New York, NY, 10008-0770, US

(73) Assignee: Central Motor Wheel Co., Ltd., Anjo-shi, Aichi (JP)

(21) Appl. No.: 12/438,790

(22) PCT Filed: Sep. 4, 2007
(86) PCT No.: PCT/JP2007/067166

§ 371 Date: Feb. 25, 2009

(30) Foreign Application Priority Data
Sep. 15, 2006 (JP) 2006-251446

(51) Int. Cl. B32B 5/16; B32B 3/26; C04B 35/64; B23P 17/00

(52) U.S. Cl. 428/328; 428/221; 264/628; 29/527.5

(57) ABSTRACT

A metal composite material which can show high wear resistance and durability when used as a sliding member and a process for producing such a metal includes material are proposed. The metal composite material (10) comprises a porous preform (1) containing porous aluminum borate particles (3) in which pores (3a) of the aluminum borate particles (3) are filled with a metal as a result of impregnation of a melt of the metal into the porous preform under pressure. In the metal composite material (10), the metal base material and the aluminum borate particles (3) are tightly bound to each other. Therefore, the metal composite material (10) has high strength and hardness and can show excellent wear resistance when used as a sliding member.

### FIELD OF THE INVENTION

The present invention relates to a metal composite material formed by pressure impregnating a melt of a metal such as an aluminum alloy into a porous preform made of a sintered reinforcement such as short fibers and particles, and to a process for producing the metal composite material.

### BACKGROUND

Parts made of a light metal, such as an aluminum alloy, having excellent properties such as lightness, high durability, and low thermal expansion coefficient tend to be increasingly used for, for example, automobiles for the purpose of improving fuel efficiency and stable running performance. In particular, in those parts such as engines which are used in severe conditions, a metal composite material composed of a light metal composited with a reinforcement material such as ceramics is used to achieve further improved lightness, durability, etc.

As a method for producing such a metal composite material, there is a known method in which a reinforcement such as short fibers or particles of metals or ceramics is sintered to form of a porous preform, the porous preform being subsequently impregnated under pressure with a melt of a metal by die casting, etc. Since the molten metal is pressure impregnated at a relatively high pressure, the preform is formed of a reinforcement such as ceramic short fibers and ceramic particles in order to prevent deformation or breakage thereof by such a pressure.

In Japanese Laid Open Patent Publication No. H09-316566 and No. 2004-263211, for example, there is disclosed a constitution in which a reinforcement such as alumina short fibers or aluminum borate whiskers is sintered to form a porous perform that is pressure impregnated with a melt of an aluminum alloy. The use of the aluminum borate whiskers as a reinforcement makes it possible to improve the strength and hardness of the metal composite material and to improve the durability and wear resistance thereof.

### DISCLOSURE OF THE INVENTION

The above-described metal composite material which has lightness and excellent durability is used as a so-called sliding member such as a cylinder or a piston that constitutes an engine. Such a sliding member repeatedly slidingly reciprocates during operation and, therefore, is required to have excellent wear resistance. Therefore, a further improvement of wear resistance is desired in a metal composite material from which such a sliding member is made.

The present invention is intended to provide a metal composite material capable of showing excellent wear resistance and of a process for producing such a metal composite material.

The present invention provides a metal composite material including a porous preform containing porous aluminum borate particles, in which pores of the aluminum borate particles are filled with a metal as a result of impregnation of a melt of the metal into the porous preform under pressure.

In the above constitution, the porous aluminum borate particles are used as a reinforcement for constituting the porous preform. The metal impregnated into the preform is also filled into pores of the aluminum borate particles. As a consequence, a binding force between the metal base material and the porous aluminum borate particles is enhanced. Additionally, the hardness and strength of the porous aluminum borate particles themselves are improved because of the presence of the metal filled in their pores.

In the case of the above-described conventional constitution using aluminum borate whiskers, the aluminum borate whiskers do not have pores. In comparison with the conventional constitution, therefore, the constitution of the present invention in which metal is filled into pores of the aluminum borate particles can provide an improved bonding strength between the aluminum borate particles and the metal base material. Moreover, because the pores of the porous aluminum borate particles are filled with the metal, the strength and hardness thereof are nearly comparable to those of the aluminum borate whiskers having no pores. For the above reasons, the metal composite material of the present invention has improved strength and hardness as compared with the conventional constitution and, therefore, shows improved durability and were resistance when used as the aforementioned sliding member.

In the case where porous aluminum borate particles are used but pores thereof are not filled with a metal, not only a binding force between the porous aluminum borate particles and the metal base material is lower than that in the constitution of the present invention, but also the strength and hardness of the aluminum borate particles per se are lower than those in the constitution of the present invention and, therefore, the durability and wear resistance are inferior as compared with those of the constitution of the present invention.

The present invention also provides a metal composite material including a porous preform containing porous aluminum borate particles. The porous preform has been impregnated with a melt of a metal under pressure so that the aluminum borate particles exposed on an outer surface of the metal composite material are maintained in a porous form, while the aluminum borate particles dispersed in an inside region of the metal composite material have their pores filled with the metal.

In the above embodiment, the outer surface on which the aluminum borate particles maintained in a porous form are exposed may be the entire outer surface of the metal composite material. Alternatively, when the metal composite material is used as a sliding member, it suffices that the aluminum borate particles maintained in a porous form are exposed on a specific outer surface that serves as a sliding surface.

The above-described sliding member such as a piston or a cylinder is generally configured to slidingly move in a given lubricant oil. Thus, the metal composite material used as a sliding member should exhibit an excellent sliding life during which the desired sliding properties are maintained in the given lubricant oil. The present inventors have made an earnest study with a view toward achieving such an excellent sliding life and, as a result, have found that aluminum borate particles in a porous form have properties of easily absorbing a grease into the pores thereof and of holding the absorbed grease therein. The present invention has been made based on the above finding.

With the above constitution, a grease can be held in the pores of the aluminum borate particles exposed on the outer surface. When a sliding member such as a piston or a cylinder formed from such a metal composite material is brought into contact with a lubricant oil or grease, the lubricant oil infiltrates into the pores of the aluminum borate particles and is held therein. Upon sliding movement of the sliding member, the lubricant oil gradually oozes. Thus, even when the sliding movement is repeated for a long period of time, the outer surface of the sliding member is prevented from being abraded because of the lubricant oil gradually oozing from the aluminum borate particles. That is, the desired sliding properties can be maintained so that the sliding life is remarkably prolonged. When a determined lubricant oil is previously applied onto the outer surface of the metal composite material on which aluminum borate particles are exposed, the lubricant oil is held in the aluminum borate particles. Thus, the application of the lubricant oil to the outer surface can also improve the sliding life in the same manner as described above.

In the above-described constitution of the present invention, the porous aluminum borate particles, pores of which are filled with a metal, are dispersed inside of the metal composite material. As a consequence, the binding force between the aluminum borate particles and the metal base material can be enhanced and, additionally, the hardness and strength of the aluminum borate particles themselves can be improved. Therefore, as compared with the constitution in which aluminum borate whiskers having no pores are used, the metal composite material of the present invention shows higher strength and higher hardness.

Like this, in the metal composite material of the present invention, the lubricant oil can be held by the aluminum borate particles maintained in a porous form and exposed on an outer surface thereof. Further, because pores of the aluminum borate particles dispersed inside the metal composite material are filled with the metal, the strength and hardness of the metal composite material are improved. Therefore, the metal composite material can constitute a sliding member showing excellent durability and wear resistance.

In the metal composite material as described above, there is proposed a constitution in which the porous preform is obtained by sintering ceramic short fibers and the porous aluminum borate particles together.

In the above constitution, the strength of the porous preform can be improved because the preform is formed using the ceramic short fibers. Further, since the porous aluminum borate particles can adhere between the ceramic short fibers, the strength between the ceramic short fibers may increase so that the porous preform has improved strength. Furthermore, the aluminum borate particles can be more easily dispersed and mixed with the ceramic short fibers and can more easily adhere between the ceramic short fibers as compared with the above-described conventionally used aluminum borate whiskers. Therefore, the porous preform has improved strength and is not deformed or broken at the time that the preform is subjected to pressure impregnation with a melt of a metal.

In the metal composite material as described above, there is proposed a constitution in which the porous aluminum borate particles have a particle diameter in the range of 3 μm to 100 μm.

The pore diameter of the porous aluminum borate particles tends to increase with an increase of the particle diameter thereof. A metal may be more easily filled in the pores as the pore diameter increases. Further, the smaller the particle diameter of the aluminum borate particles, the better becomes the dispersibility thereof in the metal base material. Accordingly, when the porous aluminum borate particles having a particle diameter in the above-described range are used, it is easy to fill a melt of a metal into the pores and to disperse the aluminum borate particles in the metal base material.

The particle diameter of the aluminum borate particles is preferably 10 μm to 60 μm, more preferably 10 μm to 40 μm, because the above-described function and effect become more excellent.

As a process for producing the above-described metal composite material, there is provided according to the present invention a process comprising a mixing step of mixing ceramic short fibers, porous aluminum borate particles, and an inorganic binder together in water to obtain an aqueous mixture; a dewatering step of removing water from the aqueous mixture to form a preliminary mixture body; a sintering step of sintering the preliminary mixture body at a predetermined temperature to form a porous preform; and a melt impregnation step of pressure impregnating the porous preform with a melt of a metal at a predetermined pressure.

In the mixing step of the above process, the ceramic short fibers and the porous aluminum borate particles are mixed so that they can be substantially uniformly dispersed in water. Thus, in the porous preform obtained through the dewatering step and the sintering step, the ceramic short fibers and the porous aluminum borate particles are substantially uniformly dispersed. At the same time, the aluminum borate particles are adhered between the ceramic short fibers. Therefore, the porous preform can show such a high strength that it can sufficiently withstand the pressure impregnation of the molten metal in the melt impregnation step.

In the melt impregnation step, the molten metal impregnated into the porous preform further infiltrates into and fills in pores of the aluminum borate particles to obtain the metal composite material of the present invention in which pores of the porous aluminum borate particles are filled with the metal.

In the process for producing a metal composite material as described above, there is proposed a process in which the inorganic binder used in the mixing step is in the form of an aqueous colloidal solution containing solid particles having a particle diameter of 10 nm to 100 nm.

The inorganic binder serves to adhere the aluminum borate particles to the ceramic short fibers. The solid particles can more easily adhere to the aluminum borate particles and to the ceramic short fibers as the particle diameter thereof increases. When the solid particles of the inorganic binder adhere to surface of the porous aluminum borate particles in a large amount, the pores of the aluminum borate particles are covered with the inorganic binder particles and, therefore, the molten metal is prevented from infiltrate into the pores. On the other hand, as the particle diameter of the solid particles decreases, they can more easily enter the pores of the aluminum borate particles and, therefore, the molten metal is prevented from infiltrating into the pores. When the particle diameter of the solid particles of the inorganic binder is within the above-described range, the inorganic binder can sufficiently adhere the aluminum borate particles to the ceramic short fibers, while permitting the molten metal to sufficiently infiltrate into the pores of the aluminum borate particles.

It is preferred that the solid particles have a particle diameter of 20 nm to 50 nm for reasons of achievement of the above-described function and effect in a more satisfactory manner.

In the process for producing a metal composite material as described above, there is proposed a process in which the porous aluminum borate particles are blended in the mixing step in such an amount that a volume ratio of the porous aluminum borate particles to the porous preform is in the range of 0.03 to 0.30.

In the above process, the amount of the aluminum borate particles is in the above-described range in terms of the volume ratio relative to the porous preform. When the amount of the aluminum borate particles is excessively small, the metal composite material cannot fully achieve the strength improving effect. When the amount is excessively large, the brittleness of the metal composite material increases. Further, when the amount of the aluminum borate particles is large, it becomes difficult for the molten metal to infiltrate into pores thereof in the melt impregnation step, because the heat of the melt is taken away by the aluminum borate particles. Furthermore, when the amount of the aluminum borate particles is large, it becomes difficult to impregnate the molten metal into the preform. Thus, the above process is capable of obtaining the metal composite material which can properly satisfy both of the strength improving effect and the moldability.

In the process for producing a metal composite material as described above, there is proposed a process in which the porous aluminum borate particles used in the mixing step have a particle diameter in the range of 3 μm to 100 μm.

The pore diameter of the porous aluminum borate particles tends to increase with an increase of the particle diameter thereof. A metal may be more easily filled in the pores as the pore diameter increases. Further, the smaller the particle diameter of the aluminum borate particles, the better becomes the dispersibility thereof in the metal base material. Accordingly, when the porous aluminum borate particles having a particle diameter in the above-described range are used, it is easy to fill a metal into the pores. The particle diameter of the aluminum borate particles is preferably 10 μm to 60 μm, more preferably 10 μm to 40 μm, because the above-described function and effect become more excellent by limiting the particle diameter.

In the process for producing a metal composite material as described above, there is proposed a process in which the melt impregnation step comprises placing the porous preform in a mold such that an outer surface of the porous preform is in contact with an interior surface of the mold, and pressure impregnating the molten metal into the porous preform.

In pressure impregnation of a porous preform with a melt of a metal, in general, the preform is placed in a mold cavity and is impregnated with the molten metal under pressure. In this case, in order to improve the impregnation efficiency of the molten metal into the porous preform, it is a general practice to preheat the porous preform and to heat and maintain the mold in which the porous preform is to be placed at a predetermined temperature. The preheating temperature of the preform is set higher than the temperature at which the mold is maintained.

In performing the melt impregnation step while preheating the preform and heating and maintaining the mold at a predetermined temperature in the above process, the porous preform is placed in the mold cavity such that an outer surface of the porous preform is in contact with an interior surface of the mold cavity. As a result, in the outer surface of the preform, the heat is taken away by the mold. Therefore, though the molten metal can be impregnated into the porous preform, it is not easy for the molten metal to infiltrate into pores of the aluminum borate particles located in the outer surface of the preform. Accordingly, in the metal composite material thus obtained, aluminum borate particles maintained in a porous form are present in an outer surface thereof, though pores of the aluminum borate particles which are present inside the preform are filled with the metal.

There is also proposed a process which further includes, after the melt impregnation step, a polishing step of polishing the outer surface of the preform which has been in contact with the interior surface of the mold in the melt impregnation step.

With the above process, the outer surface of the metal composite material which is constituted of the outer surface of the porous preform that has been in contact with the interior surface of the mold in the melt impregnation step is polished to expose the aluminum borate particles maintained in a porous form on the polished surface. Through the polishing step, such aluminum borate particles can be exposed on the outer surface of the metal composite material in a stable manner. The polishing may be carried out by various methods such as mechanical polishing using a cutter blade or a grinder, chemical polishing using a chemical agent, and combined mechanical and chemical polishing. The term “polishing” as used herein is intended not only to mean the above single polishing procedure such as mechanical polishing or chemical polishing, but also to include mechanical processing for working the outer surface into a predetermined dimension. One preferred example of such mechanical processing is to use a cutting blade such as a diamond tip cutting blade in order that the dimension of the outer surface can be adjusted with a high degree of accuracy.

### EFFECT OF THE INVENTION

Since the present invention provides a metal composite material which includes a porous preform containing porous aluminum borate particles, pores of the aluminum borate particles being filled with a metal as a result of impregnation of a melt of the metal into the porous preform under pressure, the porous aluminum borate particles and the metal base material are tightly bound to each other and, additionally, the strength and hardness of the aluminum borate particles themselves can be improved. Therefore, the metal composite material of the present invention has high strength and hardness and exhibits excellent durability and wear resistance and, hence, can sufficiently achieve the desired performance when applied to the above-described sliding member.

The present invention also provides a metal composite material includes a porous preform containing porous aluminum borate particles. The porous perform has been impregnated with a melt of a metal under pressure so that a portion of the aluminum borate particles maintained in a porous form are exposed on an outer surface of the metal composite material, with an another portion of the aluminum borate particles, pores of which are filled with the metal, being dispersed in an inside region of the metal composite material. As a result of this constitution, in the inside of the metal composite material, the porous aluminum borate particles and the metal base material are tightly bound to each other and, additionally, the strength and hardness of the aluminum borate particles themselves can be improved. On the other hand, on the outer surface of the metal base material, a lubricant oil can be held in pores of the aluminum borate particles maintained in a porous form. Therefore, when the metal composite material is used to constitute a sliding member slidingly moving in a lubricant oil, the outer surface thereof can be prevented from wearing. Further, the sliding member has a prolonged lubricating life during which the desired sliding performance can be maintained and shows excellent durability and wear resistance.

In the constitution in which the porous preform is obtained by sintering ceramic short fibers and the porous aluminum borate particles together, the porous preform has high strength because the aluminum borate particles can adhere between the ceramic short fibers. Therefore, the porous preform is prevented from deforming or breaking at the time the preform is subjected to pressure impregnation with a melt of a metal under a relatively high pressure.

In the constitution in which the porous aluminum borate particles have a particle diameter in the range of 3 μm to 100 μm, a metal can be sufficiently filled into the pores of the porous aluminum borate particles. Therefore, the aforementioned function and effect of the present invention can be more properly achieved.

As a process for producing the above-described metal composite material, the present invention provides a process including a mixing step of mixing ceramic short fibers, porous aluminum borate particles, and an inorganic binder together in water to obtain an aqueous mixture; a dewatering step of removing water from the aqueous mixture to form a preliminary mixture body; a sintering step of sintering the preliminary mixture body at a predetermined temperature to form a porous preform; and a melt impregnation step of pressure impregnating the porous preform with a melt of a metal at a predetermined pressure. According to the above process, the porous preform containing porous aluminum borate particles dispersed therein can be formed with pores of the porous aluminum borate particles being filled with the metal. Thus, the process can form the metal composite material containing the porous aluminum borate particles dispersed therein with pores of the porous aluminum borate particles being filled with the metal.

In the constitution in which the inorganic binder used in the mixing step is in the form of an aqueous colloidal liquid containing solid particles having a particle diameter of 10 nm to 100 nm, the pores of the porous aluminum borate particles are not covered with solid particles of the inorganic binder so that a melt of a metal can easily and stably infiltrate into the pores of the aluminum borate particles.

In the production process in which the porous aluminum borate particles are blended in the mixing step in such an amount that a volume ratio of the porous aluminum borate particles to the porous preform is in the range of 0.03 to 0.30, it is possible to control the heat loss during the course of impregnation of the molten metal in the melt impregnation step. Therefore, the molten metal can be stably filled into the pores of the aluminum borate particles.

In the production process in which the porous aluminum borate particles used in the mixing step have a particle diameter in the range of 3 μm to 100 μm, the molten metal can be stably and easily filled into the pores of the aluminum borate particles because of the suitable size of the pores.

In the production process in which the melt impregnation step includes placing the porous preform in a mold such that an outer surface of the porous preform is in contact with an interior surface of the mold, and pressure impregnating the molten metal into the porous preform, heat of the outer surface of the porous preform which has been in contact with the mold is taken away by the mold. Thus, it is possible to produce obtain a metal composite material in which the aluminum borate particles exposed on an outer surface of the porous preform are maintained in a porous form, while the aluminum borate particles dispersed in an inside region of the porous preform have their pores filled with the metal.

In the production process which further includes, after the melt impregnation step, a polishing step of polishing the outer surface of the preform which has been in contact with the interior surface of the mold in the melt impregnation step, it is possible to easily and stably form the polished outer surface on which the porous preform maintained in a porous form are exposed.

### BRIEF DESCRIPTION OF THE DRAWINGS

FIG. 1 is a view explanatory of a preform forming step for forming a preform of Example 1.

FIG. 2 is a view explanatory of steps of molding, from the preform formed in the preform forming step, a metal composite material 10 through a die casting step and a cutting work step.

FIG. 3 shows (A) a magnification photograph and (B) a higher magnification photograph of porous aluminum borate particles 3.

FIG. 4 shows a magnification photograph of aluminum borate particles constituting the porous preform of Example 1.

FIG. 5 shows a magnification photograph of a metal composite material molded from the porous preform.

FIG. 6 shows a magnification photograph of an inside peripheral surface of a metal composite material of Example 2.

### DETAILED DESCRIPTION OF THE INVENTION

Embodiments of the present invention will be described in detail with reference to the accompanying drawings.

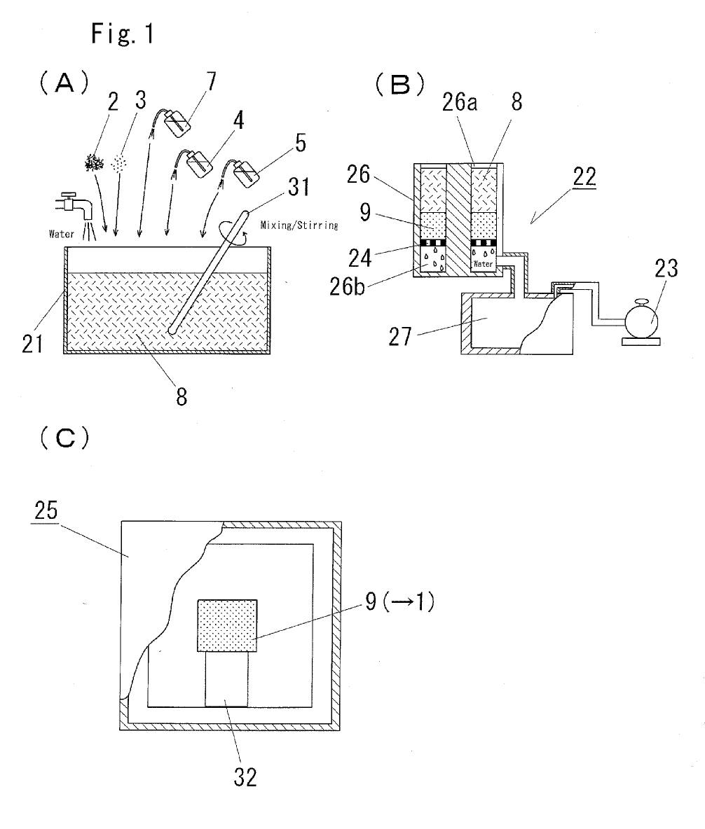

FIG. 1 depicts a view illustrating steps for forming a preform 1. The preform forming step includes a mixing step, a dewatering step, a drying step, and a sintering step. FIG. 1(A) shows the mixing step in which raw materials are stirred in water contained in a predetermined vessel 21 using a stirring rod 31 and nearly homogeneously mixed to obtain an aqueous mixture 8. The aqueous mixture 8 is then transferred from the vessel 21 to a suction molding device 22. FIG. 1(B) shows the dewatering step in which water of the aqueous mixed liquid 8 is suctioned through a filter 24 by a vacuum pump 23 to produce a preliminary mixture body 9. The preliminary mixture body 9 is taken out of the suction molding device 22 and transferred to the drying step (not shown) for the sufficient drying thereof. FIG. 1(C) shows the sintering step in which the preliminary mixture body 9 is placed on a table 32 within a heating furnace 25 and is heated and sintered at a predetermined temperature to obtain the desired porous preform 1.

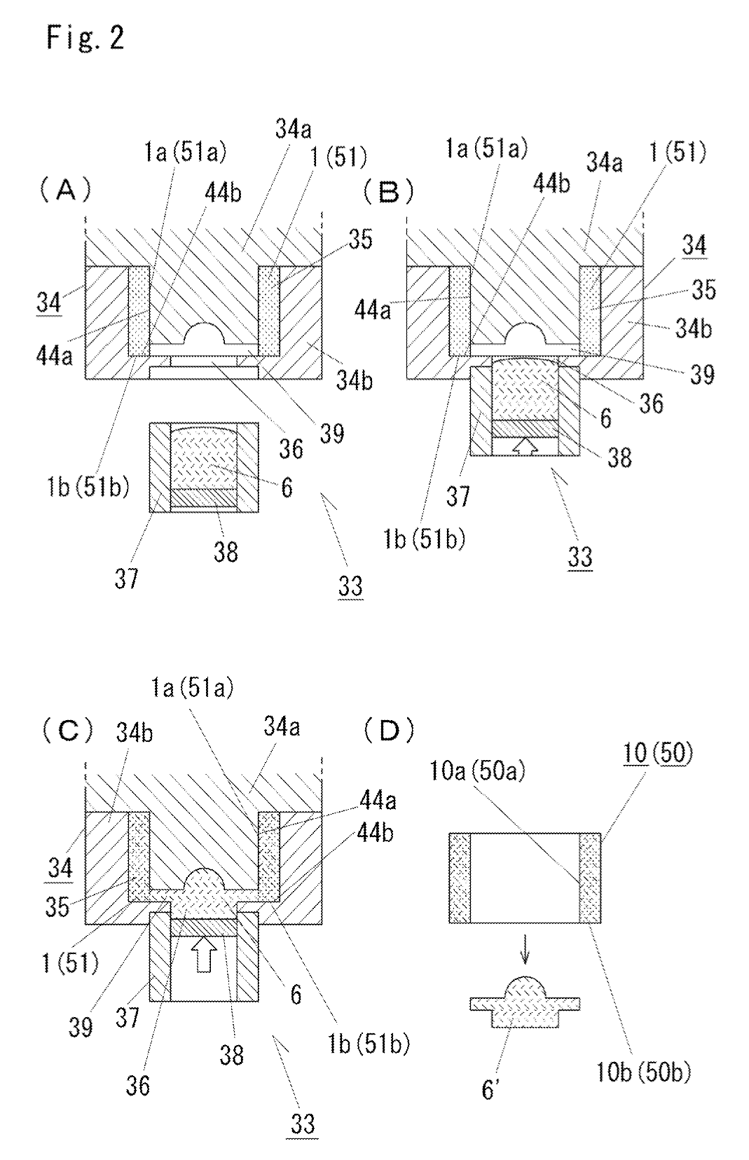

Then, the porous preform 1 is impregnated with a melt 6 of an aluminum alloy in a die casting step shown in FIGS. 2(A) to 2(C) to produce a metal composite material 10. The die casting step is carried out with a die casting machine 33 which, as shown in FIG. 2(A), includes a mold 34 having a cavity 35 with a predetermined shape, and a sleeve 37 configured to temporarily retain a melt 6 to be injected to the cavity 35 and to inject the melt 6 by the action of a plunger tip 38 adapted to advance and retract within the sleeve 37. In the die casing step, the preform 1 is inserted within the cavity 35 of the mold 34. The melt 6 to be injected to the cavity 35 is supplied to the sleeve 37 with the plunger tip 38 being maintained in the retracted position. Then, the sleeve 37 is connected to a gate 36 of the mold 34 as shown in FIGS. 2(B) and 2(C). The plunger tip 38 is then driven to the advanced position to inject the melt 6 contained in the sleeve 37 into the cavity 35 to pressure impregnate the melt 6 into the porous preform 1.

The above die casting step constitutes the melt impregnation step of the process of the present invention.

The die casting step is followed by a cutting work step to trim the obtained composite material with a lathe to the desired shape and dimension and then a polishing step to mechanically polish, using a milling machine, a determined outer surface of the composite material (hereinafter described inside peripheral surface) which is to serve as a sliding surface. Through these steps, a metal composite material 10 having the desired shape and dimension is obtained.

Concrete examples of the metal composite materials 10 and 50 produced through a forming step to obtain a preform 1, a die casting step to impregnate the preform 1 with a melt 6 of an aluminum alloy, a cutting work step, and a polishing step to mechanically polish an outer surface will be described below.

### Example 1

In the forming step for forming the preform 1, the following materials (i) to (iv) are added to water contained in a vessel 21 and are mixed in the mixing step (FIG. 1(A)):

(i) Alumina short fibers 2 (average fiber diameter: 3 μm, average fiber length: 400 μm);
(ii) Aluminum borate particles 3 (9Al₂O₃.2B₂O₃, average particle diameter: 40 μm);
(iii) Silica sol 4 (aqueous colloidal liquid, hydrogen ion concentration pH: 10, concentration: about 30%); and
(iv) Polyacrylamide 7 (aqueous solution, concentration: about 10%).

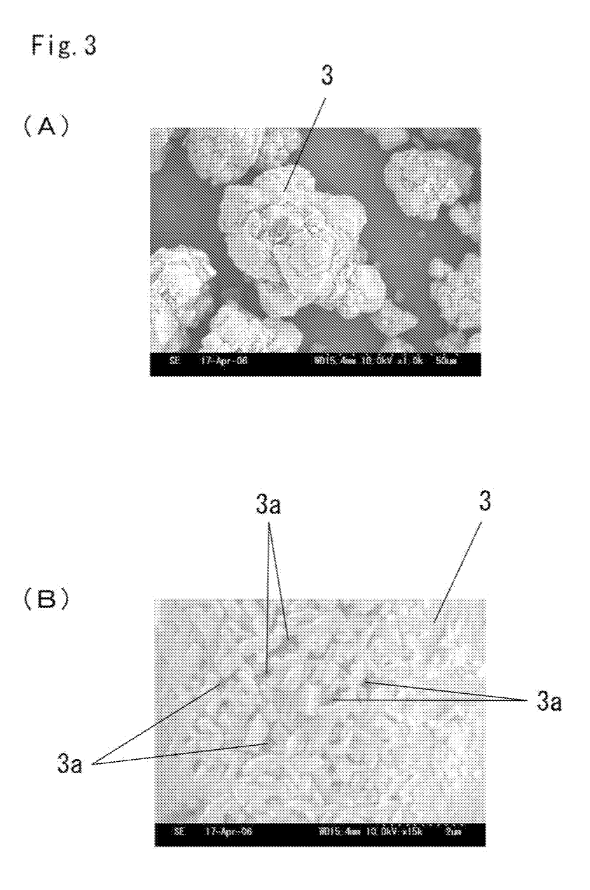

The aluminum borate particles 3 used are in a porous form and have a number of fine pores 3a as shown in FIG. 3. The silica sol 4 is a so-called inorganic binder and has an average diameter of 20 nm.

The above average fiber diameter, average fiber length, and average particle diameter are average values of the fiber diameters, fiber lengths, and particle diameters, respectively, with certain variations. The alumina short fibers 2 and aluminum borate particles 3 are so-called reinforcements.

The amount of the alumina short fibers 2 is adjusted so that the volume fraction thereof is about 5% by volume based on the volume of the preliminary mixture body 9 shaped in the dewatering step and drying step. Similarly, the amount of the porous aluminum borate particles 3 is adjusted so that the volume fraction thereof is about 10% by volume based on the volume of the preliminary mixture body 9.

The silica sol 4 is added in an amount so that the weight ratio thereof to a total weight of the alumina short fibers 2 and the aluminum borate particles 3 is about 0.05. Thus, the weight of the silica particles contained in the silica sol 4 used is about 0.015 in terms of weight ratio thereof to the weight of the aluminum borate particles 3.

The aqueous solution containing the above-described materials (i) to (iv) is stirred with the stirring rod 31 to obtain an aqueous mixture 8 in which the above materials are nearly uniformly mixed.

The aqueous mixture 8 is then transferred to a suction molding device 22 to perform a dewatering step (FIG. 1(B)). The suction molding device 22 includes a cylindrical liquid retaining section 26 having an interior space divided with a filter 24 into an upper region 26a into which the aqueous mixture 8 is supplied and a lower region 26b; a water collecting section 27 provided beneath the liquid retaining section 26 for liquid communication with the lower region 26b of the liquid retaining section 26; and a vacuum pump 23 connected to the water collecting section 27 for suctioning water from the liquid retaining section 26 through the water collecting section 27.

In the dewatering step, after the aqueous mixture 8 has been supplied into the upper region 26a of the liquid retaining section 26 of the suction molding device 22, the vacuum pump 23 is driven to suction water of the aqueous mixture 8 through the water collecting section 27 and the lower region 26b of the liquid retaining section 26. Thus, the water of the aqueous mixture 8 flows down through the filter 24 to obtain a preliminary mixture body 9 in the form of a cylinder composed of a mixture of the above-described materials. The preliminary mixture body 9 is taken out of the suction molding device 22 and placed in a drying furnace at about 120° C. to perform a drying step for sufficiently remove water therefrom (not shown).

In the dewatering step, each of the materials contained in the aqueous mixture 8 is also suctioned. As the suction proceeds, the alumina short fibers 2 and aluminum borate particles 3 are aggregated in a suitable degree by the polyacrylamide contained in the aqueous mixture 8. Thus, adjacent alumina short fibers 2 and aluminum borate particles 3 are adhered to each other with the silica sol 4. Therefore, in the preliminary mixture body 9, the adjacent alumina short fibers 2 are sufficiently bonded to each other while the porous aluminum borate particles 3 are bonded between the alumina short fibers 2. Thus, the cylindrical preliminary mixture body 9 is prevented from being deformed or broken during its transference to the succeeding sintering step.

In this Example, silica sol 4 containing silica particles having a particle diameter of 20 nm is used. Since the silica particles have a relatively small size, it is difficult for the silica particles to agglomerate on the porous aluminum borate particles 3. Therefore, pores 3a of the porous aluminum borate particles 3 are not covered with the silica particles which are deposited thereon. Namely, the aluminum borate particles 3 are present with the porous state being maintained.

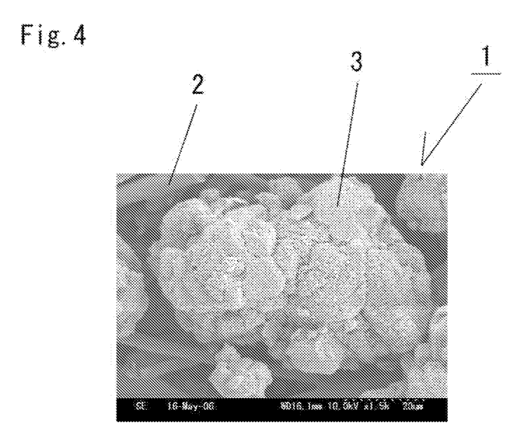

Next, the above-described sintering step (FIG. 1(C)) is conducted. The preliminary mixture body 9 is placed on a table 32 disposed within the heating furnace 25 and is heated to about 1,150° C. and maintained at that temperature for about 1 hour to sinter the alumina short fiber 2 and the aluminum borate particles 3, thereby obtaining a cylindrical preform 1. As shown in FIG. 4, in the cylindrical perform 1, the aluminum borate particles 3 are maintained in a porous form. In FIG. 4, pores 3a are not shown.

In the porous preform 1, the adjacent alumina short fibers 2 and aluminum borate particles 3 are relatively strongly bonded to each other with the crystallized silica particles, which are deposited on surfaces of the alumina short fibers 2 and aluminum borate particles 3, such that relatively large void spaces being formed therebetween. Thus, the porous preform has good air permeability. In the porous preform 1, the alumina short fibers 2 and aluminum borate particles 3 are present and nearly uniformly dispersed throughout its entirety.

Next, the above-described die casting step (FIG. 2) is carried out. A die casting machine 33 has a mold 34 which composed of an upper mold 34a having a convex shape and a lower mold 34b having a concave shape and which is adapted to define a cylindrical cavity 35. The lower mold 34b of the mold 34 has a connecting portion (not shown) to which a sleeve 37 is connected and a gate 36 through which a melt 6 contained in the sleeve 37 flows into the cavity 35 when the sleeve 37 is connected to the lower mold 34b. When the upper mold 34a and lower mold 34b are in engagement with each other, there is also defined a runner 39 through which the cavity 35 and the gate 36 are in fluid communication with each other, that is, through which the melt 6 introduced from the gate flows into the cavity 35.

The cylindrical porous preform 1 has a dimension which is slightly smaller than the dimension of the cavity 35 of the die casting machine 33. Therefore, when the porous preform 1 is placed in the cavity 35, the lower surface 1b of the preform 1 is brought into contact only with a bottom surface 44b of the mold 34 which constitutes the bottom of the cavity 35. That is, the other surfaces of the preform 1 (inside peripheral surface 1a, outer peripheral surface (not shown) and upper surface (not shown)) are not in engagement with the interior surface of the mold 34.

In the die casting step, the porous preform 1 is first pre-heated to about 600° C. while the mold 34 is maintained at 200° C. Then, as shown in FIG. 2(A), the pre-heated preform 1 is placed in the lower mold 34 with which the upper mold 34a is then brought into fitting engagement so that the porous preform 1 is accommodated in the cylindrical cavity 35 of the mold 34. In this state, the porous preform 1 is supported with its lower surface 1b being in contact with the bottom surface 44b of the mold 34 which constitutes the bottom of the cavity 35.

The melt 6 of an aluminum alloy maintained at about 800° C. is supplied to the sleeve 37 located beneath the mold 34 with a plunger tip 38 being maintained in a retracted position (not shown). In the present Example, JIS ADC12 is used as the aluminum alloy.

Then, as shown in FIG. 2(B), the sleeve 37 is moved upward to connect an upper end portion of the sleeve 37 to the gate 36 of the mold 34. The plunger tip 38 is driven from the retracted position to an advanced position at a predetermined speed to inject the melt 6 contained in the sleeve 37 into the cavity 35. In this Example, the driving speed of the plunger tip 38 is controlled so that the melt 6 from the gate 36 is injected at an applied pressure of about 500 atm. In a manner as described above, the aluminum alloy melt 6 is impregnated under pressure into the preform disposed within the cavity 35.

As shown in FIG. 2(C), the plunger tip 38 is stopped moving to terminate the injection of the melt 6 when the melt is filled in the cavity 35. After the melt has been cooled, the sleeve 37 is moved downward and disengaged from the mold 34. The upper mold 34a and lower mold 34b of the mold are separated from each other to take out the metal composite material 10 from the mold 34 as shown in FIG. 2(D). The metal composite material 10 is formed of the aluminum alloy 6′ as a base material with which the aluminum short fibers 2 and the aluminum borate particles 3 are composited.

The metal composite material 10 thus formed in the above die casting step is then subjected to cutting work using a lathe. In the cut processing step for the metal composite material 10 taken out of the mold 34, as shown in FIG. 2(D), those portions thereof which correspond to the gate 36 and runner 39, flashes, etc. are removed and, further, the composite material is trimmed to the desired cylindrical form and dimension. The cut processing step is followed by a polishing step for mechanically polishing, using a milling device, the inside peripheral surface 10a. In the present Example, the mechanical polishing is carried out by cutting with a diamond tip.

In Example 1, the inside peripheral surface 10a of the metal composite material 10 is intended to serve as a sliding surface when the composite material is used as a sliding member. The polished inside peripheral surface 10a is the “outer surface” according to the present invention.

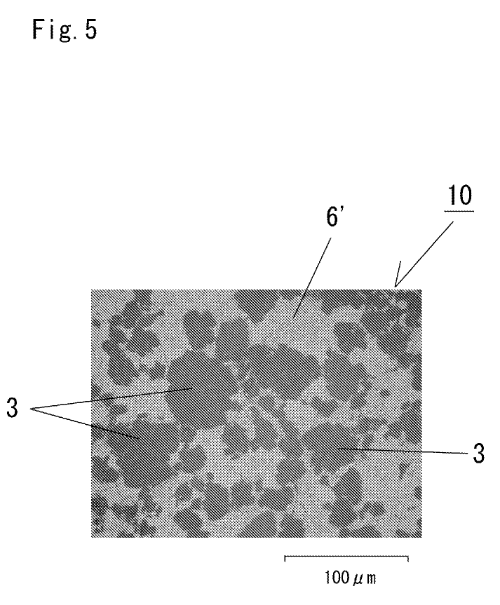

The observation of the thus obtained metal composite material 10 reveals that, as shown in FIG. 5, the aluminum borate particles 3 are dispersed therein and pores 3a (see FIG. 3) of the aluminum borate particles 3 are filled. This indicates that the aluminum alloy is filled in the pores 3 of the aluminum borate particles 3.

That is, in the above-described die casting step, the melt 6 of the aluminum alloy is impregnated into the preheated porous preform 1 under pressure, so that the melt 6 infiltrates throughout the porous preform l. Further, since the aluminum borate particles 3 contained in the porous preform 1 have a multiplicity of fine pores 3a, the melt 6 also infiltrates into the pores 3a. As a consequence, the metal composite material 10 containing the aluminum borate particles 3, pores 3a of which are filled with the aluminum alloy, is formed.

Since the porous preform 1 is placed in the cavity 35 with its lower surface 1b being supported on the bottom surface 44b of the mold 34, the heat of the lower surface 1b is taken away by the mold 34 having a lower temperature than that of the perform 1. Therefore, in the surface region of the lower surface 1b, the impregnatability of the melt 6 tends to reduce. In actual, however, since the surface region of the lower surface 1b is located adjacent to the runner 39, the impregnatability hardly reduces, i.e. the melt 6 is sufficiently impregnated into the preform. The aluminum borate particles 3 which are present in the surface region of the lower surface 1b also loses its heat and, therefore, the impregnatability of the melt 6 into the pores 3a thereof tends to reduce. Even when the pores 3a of the aluminum borate particles 3 which are present in the surface region of the lower surface 1b are failed to be sufficiently filled with the aluminum alloy, such a surface region can be removed in the cutting work step and polishing step which are carried out after the die casting step to obtain the metal composite material 10 in which the aluminum borate particles 3, whose pores 3a are filled with the aluminum alloy, are dispersed.

The metal composite material 10 of Example 1 is sufficiently impregnated with the aluminum alloy 6′ as shown in FIG. 5 and is free of mold cavities (unimpregnated regions). Further, no cracks or fractures are formed in the metal composite material 10. Accordingly, the porous preform 1, formed by sintering the alumina short fibers 2 and the porous aluminum borate particles 3 together, has excellent air permeability as well as strength sufficient enough to withstand the high pressure impregnation of the melt 6.

### Example 2

In Example 2, a desired porous preform 51 is formed by the same preform forming step (see FIG. 1) as that in Example 1. The porous preform 51 of Example 2, however, has an outer dimension such that the entire inside peripheral surface 51a is in engagement with the inside interior peripheral surface 44a of the mold 34 when the preform 51 is placed in the cavity 35 of the mold 34 used in the die casting step (see FIG. 2).

In the mixing step, the same aqueous mixture 8 as that in Example 1 is prepared using the same materials in the same amounts as those in Example 1. Then, a dewatering step, a drying step, and a sintering step are carried out under the same conditions as those in Example 1.

The porous preform 51 of Example 2 has the same constitution as the porous preform 1 of Example 1 except that the preform 51 has slightly larger outer dimension as compared with the preform 1 of Example 1. That is, in the porous preform 51, too, the alumina short fibers 2 and the porous aluminum borate particles 3 are nearly uniformly dispersed throughout the preform with the neighboring alumina short fibers and aluminum borate particles being tightly bonded to each other. Further, the preform 51 has a relatively large void spaces and excellent air permeability. The aluminum borate particles 3 are maintained in a porous form.

The cylindrical porous preform 51 thus formed is impregnated with a melt 6 of an aluminum alloy in a die casting step in the same manner as that in Example 1 (see FIG. 2) to form a metal composite material 50. In Example 2, the entire inside peripheral surface 51a of the porous preform 51 is in engagement with the inside interior peripheral surface 44a of the mold 34 which constitutes an outer periphery of the cavity 35 when the porous preform 51 is placed in the cavity 35 of the mold 34. Further, similar to Example 1, the porous preform 51 is supported within the cavity 35 with its lower surface 51b being in contact with the bottom surface 44b of the mold 34 which constitutes the bottom of the cavity 35.

The temperature of the preheating of the porous preform 51, the heating of the mold 34, and the melt 6 are similar to those in Example 1.

Subsequent to above die casting step, the obtained metal composite material is subjected to a cutting work step to remove unnecessary portions thereof and to trim it to the desired shape and dimension using a lathe. This is followed by a polishing step for polishing, using a milling device, the inside peripheral surface 50a. The cutting and polishing of the inside peripheral surface 50a are performed in a slight degree so that the aluminum borate particles 3 present in the surface region of the composite material are exposed thereon. Similar to Example 1, the lower surface 50b is cut in such an amount that the surface region thereof is removed. The thus obtained metal composite material 50 has nearly the same shape and dimension as those in Example 1. The mechanical polishing by the milling device constitutes the polishing step of the process of the present invention.

Similarly to Example 1, the inside peripheral surface 50a of the metal composite material 50 of Example 2 is intended to serve as a sliding surface when the composite material is used as a sliding member. The polished inside peripheral surface 50a is the “outer surface” according to the present invention.

Similarly to Example 1, the metal composite material 50 of Example 2 includes the aluminum alloy 6′, the aluminum short fibers 2, and the aluminum borate particles 3, which are composited with each other. The observation of the inside of the metal composite material 50 reveals that, similarly to Example 1, the pores 3a of the aluminum borate particles 3 are filled with the aluminum alloy 6′ (see FIG. 5). Such aluminum borate particles 3 are dispersed in the composite material. Such a structure is formed because, similarly to Example 1, the melt 6 of the aluminum alloy also infiltrated into the pores 3a of the aluminum borate particles 3 during the die casting step. In the surface regions of the upper surface (not shown), lower surface 50b, and outside peripheral surface (not shown) of the metal composite material 50, too, the aluminum borate particles 3, pores 3a of which are filled the aluminum alloy 6′, are dispersed.

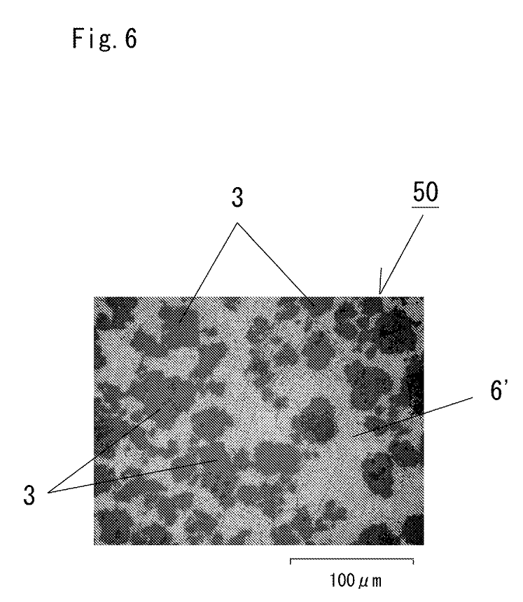

The observation of the inside peripheral surface 50a of the metal composite material 50 reveals that, as shown in FIG. 6, the aluminum borate particles 3 maintained in a porous form are exposed thereon. Such a structure is formed because the inside peripheral surface 51a of the porous preform 51 was in engagement with the inside interior peripheral surface 44a of the mold 34 during the die casting step. That is, the heat of the inside peripheral surface 51a of the preform 51 was taken away by the mold so that the melt 6 of the aluminum alloy was not filled in the pores 3a of the aluminum borate particles 3 which were present in the surface region of the inside peripheral surface 51a. The die casting step is followed by a polishing step to obtain a metal composite material 50 in which the aluminum borate particles 3 maintained in a porous form are exposed on the inside peripheral surface 50a.

Even when the heat of the inside peripheral surface 51a of the porous preform 51 is taken away from the preform 34, the melt of the aluminum alloy may enter around the openings of the pores 3a of the aluminum borate particles 3 which are present in the surface region of the inside peripheral surface 51a. Even when the openings of the pores 3a are covered with the aluminum alloy 6′, however, surface regions of the aluminum borate particles 3 which are present in the inside peripheral surface 50a of the metal composite material 50 are cut when the inside peripheral surface 50a of the metal composite material 50 is cut in the polishing step, so that the aluminum alloy 6′ covering the openings of the pores 3a of the aluminum borate particles 3 are removed. Accordingly, the aluminum borate particles 3 maintained in a porous form are exposed on the inside peripheral surface 50a of the metal composite material 50.

Thus, as described previously, the aluminum borate particles 3 exposed on the inside peripheral surface 50a of the metal composite material 50 of Example 2 are maintained in a porous form, while the aluminum borate particles 3 dispersed in an inside region of the composite material have their pores 3a filled with the aluminum alloy 6′. As described above, in Example 2, the inside peripheral surface 50a of the metal composite material 50 is intended to serve as a sliding surface when the composite material is used as a sliding member.

In Example 2, the metal composite material is prepared in the same manner as that in Example 1 except for using the porous preform 51 having a greater dimension and for placing the porous preform in the cavity 35 such that the inside peripheral surface 51a thereof is in contact with the inside interior peripheral surface 44a of the mold 34 in the die casting step. Thus, in the above description, the forming step and other constitution which are the same as those in Example 1 are designated as the same reference numerals and the explanation thereof is not repeated.

The metal composite materials 10 and 50 obtained in Examples 1 and 2 were measured for their strength and hardness. The strength was measured by a tensile test while the hard was measured by a Vickers hardness test. For the comparison purpose, the same aluminum alloy (JIS ADC12) as used as the base material for the metal composite materials 10 and 50 was measured for its strength and hardness.

The tensile test was carried out in accordance with JIS Z2201. The test piece had a columnar shape with an outer diameter in a parallel portion of about 5 mm. The tensile test was carried out with a gauge length of about 25 mm to measure the tensile strength and 0.2% proof stress. The tensile strength was so-called nominal stress and was determined from the maximum load required for breakage of the test piece. The test piece used in the tensile test was prepared from each of the metal composite materials 10 and 50 obtained in Examples 1 and 2. The test piece obtained from the metal composite material 50 of Example 2 was prepared such that it did not contain the inside peripheral surface 50a of the metal composite material 50. The test piece of the reference aluminum alloy was prepared so as to have the same shape as those of the composite materials.

The Vickers hardness test was carried out in accordance with JIS Z2244. In the test, a pyramidal indenter was pressed against each of the inside peripheral surfaces 10a and 50a of the metal composite materials 10 and 50 obtained in Examples 1 and 2 at a load of 98 N to measure the hardness thereof. Since the metal composite materials 10 and 50 were each intended to be used as a sliding member such that the inside peripheral surfaces 10a and 50a thereof serve as a sliding surface, the hardness of the inside peripheral surfaces 10a and 50a was measured. The hardness of the aluminum alloy was also measured in the same manner as above.

The tensile test and Vickers hardness test revealed that the metal composite material 10 of Example 1 had a tensile strength of 340 MPa, a 0.2% proof stress of 220 Mpa, and a Vickers hardness of 130 Hv.

The metal composite material 50 of Example 2 had a tensile strength of 320 MPa, a 0.2% proof stress of 200 MPa and a Vickers hardness of 110 Hv.

The aluminum alloy had a tensile strength of 310 MPa, a 0.2% proof stress of 180 Mpa, and a Vickers hardness of 100 Hv.

From the above results, it is confirmed that the metal composite materials 10 and 50 obtained in Examples 1 and 2 have significantly improved strength and hardness as compared with those of the aluminum alloy. Such high strength and hardness are obtained because the aluminum borate particles 3 whose pores 3a are filled with the aluminum alloy 6′ are dispersed in the metal composite materials 10 and 50 so that the strong bonding between the base material of the aluminum alloy 6′ and the aluminum borate particles 3 are established. When the metal composite materials 10 and 50 having such high strength and hardness are used as a sliding member, excellent durability and wear resistance can be achieved.

The metal composite material 10 of Example 1 has a higher Vickers hardness than that of the metal composite material 50 of Example 2. The reason for this is that, whereas, in Example 1, the aluminum borate particles 3 in the inside peripheral surface 10a are filled with the aluminum alloy 6′, but the aluminum borate particles 3 exposed on the inside peripheral surface 50a in Example 2 are maintained in a porous form.

That is, the hardness of the porous aluminum borate particles 3 is improved when their pores 3a are filled with the aluminum alloy 6′. More specifically, while the hardness of the porous aluminum borate particles 3 is about 200 to 300 Hv as measured in terms of Vickers hardness, the hardness of the aluminum borate particles 3 having pores 3a filled with the aluminum alloy is 400 to 600 Hv. Therefore, in Example 1, the hardness of the aluminum borate particles 3 which are present in the inside peripheral surface 10a is higher than that in Example 2. Accordingly, the Vickers hardness in Example 1 as a whole is much higher than that in Example 2.

The tensile test was carried out such that the test piece sampled in Example 2 did not contain the inside peripheral surface 5a of the metal composite material 50. Therefore, the strength is similar to that in Example 1.

From each of the metal composite materials 10 and 50 obtained in Examples 1 and 2, a rectangular test piece having a rectangular surface with a dimension of 30 mm×40 mm was cut out for measuring oil retention properties thereof. The test for measuring the oil retention property was carried out as follows. An automobile engine oil (lubricating oil) was applied to each of the inside peripheral surfaces 10a and 50a of the test pieces of Examples 1 and 2. The weights of each of the test pieces before and after the application of the oil were measured. In the above test, the oil retention property is measured for the inside peripheral surfaces 10a and 50a of the metal composite materials 10 and 50, since, in Examples 1 and 2, the peripheral surfaces 10a and 50a are intended to serve as a sliding surface when the metal composite materials 10 and 50 are each used as a sliding member.

The test results of the oil retention property were such that the test piece of Example 1 showed a weight increase of about 0.2 mg, while the test piece of Example 2 showed a weight increase of about 5.2 mg. Thus, it is revealed that the test piece of Example 2 has higher oil retention property as compared with the test piece of Example 1. The reason for this is that the aluminum borate particles 3 maintained in a porous state are exposed on the inside peripheral surface 50a of the metal composite material 50 in Example 2 and that the engine oil is absorbed and retained in the pores 3a of the porous aluminum borate particles 3. In the case of Example 1, on the other hand, the pores 3a of the aluminum borate particles 3 which are present in the inside peripheral surface 10a of the metal composite material 10 are filled with the aluminum alloy 6′ and, therefore, the engine oil cannot infiltrate thereinto and cannot be retained in the peripheral surface.

When the metal composite material 50 is used as a sliding member, since the metal composite material 50 in Example 2 retains an oil in the aluminum borate particles 3 exposed on the inside peripheral surface 50a which serves as a sliding surface, the oil retained in the aluminum borate particles 3 oozes upon sliding movement thereof. Therefore, the sliding member can achieve excellent sliding property. As a consequence, the sliding member formed of the metal composite material 50 has not only improved wear resistance as a whole but also shows an improved durability because the sliding life during which the desired sliding property can be maintained is prolonged. Accordingly, the metal composite material 50 in Example 2 can achieve sufficient wear resistance because of its excellent oil retention property, though the hardness of the inside peripheral surface 50a is lower than that of Example 1.

In the metal composite material 50 of Example 2, it is only the inside peripheral surface 50a that the aluminum borate particles 3 exposed thereon are maintained in a porous form. However, in another constitution of the present invention, the aluminum borate particles 3 maintained in a porous form may be exposed on the entire outer surface or on the inside and outside peripheral surfaces of the metal composite material. That is, when the metal composite material is used as a sliding member, it suffices that the aluminum borate particles 3 maintained in a porous form are exposed on at least the sliding surface thereof in order to sufficiently obtain the function and effect of the present invention.

The present invention is not limited to the above-described embodiments. The embodiments and other constitutions thereof may be properly changed within the scope of the gist of the present invention. For example, as the reinforcement, there may be used not only the alumina short fibers but also other short fibers, whiskers and particles such as ceramic short fibers and ceramic particles.

1. A metal composite material comprising a porous preform containing porous aluminum borate particles, pores of the aluminum borate particles being filled with a metal as a result of impregnation of a melt of the metal into the porous preform under pressure.

2. A metal composite material comprising a porous preform containing porous aluminum borate particles, the porous preform having been impregnated with a melt of a metal under pressure so that the aluminum borate particles exposed on an outer surface of the metal composite material are maintained in a porous form, while the aluminum borate particles dispersed in an inside region of the metal composite material have their pores filled with the metal.

3. The metal composite material according to claim 1, wherein the porous preform is obtained by sintering ceramic short fibers and the porous aluminum borate particles together.

4. The metal composite material according to claim 1, wherein the porous aluminum borate particles have a particle diameter in the range of 3 μm to 100 μm.

5. A process for producing a metal composite material, comprising
a mixing step of mixing ceramic short fibers, porous aluminum borate particles, and an inorganic binder together in water to obtain an aqueous mixture;
a dewatering step of removing water from the aqueous mixture to form a preliminary mixture body,
a sintering step of sintering the preliminary mixture body; at a predetermined temperature to form a porous perform; and
a melt impregnation step of pressure impregnating the porous preform with a melt of a metal at a predetermined pressure.

6. The process for producing a metal composite material according to claim 5, wherein the inorganic binder used in the mixing step is in the form of an aqueous colloidal solution containing solid particles having a particle diameter of 10 nm to 100 nm.

7. The process for producing a metal composite material according to claim 5, wherein the porous aluminum borate particles are blended in the mixing step in such an amount that a volume ratio of the porous aluminum borate particles to the porous preform is in the range of 0.03 to 0.30.

8. The process for producing a metal composite material according to claim 5, wherein the porous aluminum borate particles used in the mixing step have a particle diameter in the range of 3 μm to 100 μm.

9. The process for producing a metal composite material according to claim 5, wherein the melt impregnation step comprises placing the porous preform in a mold such that an outer surface of the porous preform is in contact with an interior surface of the mold, and pressure impregnating the molten metal into the porous preform.

10. The process for producing a metal composite material according to claim 9, further comprising, after the melt impregnation step, a polishing step of polishing the outer surface of the preform which has been in contact with the inside surface of the mold in the melt impregnation step.
